(19) United States
(12) Patent Application Publication
(10) Pub. No.: US 2019/0156630 A1
(43) Pub. Date: May 23, 2019

(54) MULTIPLE PROGRESSIVE REWARD VALUATION AND ACCRUAL

(71) Applicant: Circle Eight Games Inc., Reno, NV (US)

(72) Inventors: Ryan Cuddy, Reno, NV (US); Charles Cuddy, Reno, NV (US); Christopher Lundy, Reno, NV (US); Lyndsay Berger, Reno, NV (US); Kyle Altemara, Reno, NV (US); David Williams, Carson City, NV (US)

(21) Appl. No.: 16/190,046

(22) Filed: Nov. 13, 2018

Related U.S. Application Data
(60) Provisional application No. 62/584,915, filed on Nov. 13, 2017.

(51) Int. Cl. G07F 17/32; G07F 17/34

(52) U.S. Cl. CPC G07F 17/3258; G07F 17/34; G07F 17/3213

(57) ABSTRACT

Methods of providing progressive casino games with multiple reward accrual features are presented. Progressive jackpots awards are determined via bonus valuation of selected symbols from a previous single spin outcome without the necessity of a second spin. When a single symbol or multiple symbols are included within more than one unique winning payline, the player's progressive award is comprised of the sum of each of the more than one unique payline awards.

### COPYRIGHT STATEMENT

This patent document contains material subject to copyright protection. The copyright owner consents to the storage and reproduction of the instant disclosure in exactly the form it appears in the Patent and Trademark Office records for all purposes associated with the instant application and patent. However, Applicant, its agents, and its assigns reserve all copyright rights to this original work for any and all other purposes, particularly but not limited to such rights prohibiting appropriation of the original material herein for unauthorized use by other parties for any purpose. To the extent that any material herein may legitimately fall within the scope of any copyright protection previously claimed by another party, including any material presented herein believed subject to the “Fair Use” doctrine, Applicant disclaims any intellectual property ownership thereof or copyright protection therefore.

### BACKGROUND

Progressive casino games are well-known in the art. The common characteristic among the myriad embodiments of progressive games is that a portion of each gaming wager placed by a player is set aside in one or more progressive jackpot(s) separate from that associated with the base game and used exclusively to pay awards for the progressive aspect(s) of the game. Progressive games may provide one or more progressive jackpots with varying amounts. The amount in each progressive jackpot is awarded when a player achieves one or more specially-defined progressive game outcomes specific to that particular jackpot, typically with a higher volatility than normally provided in the base game. Larger jackpots have smaller odds of being won and are therefore awarded less frequently, on average, than are the smaller jackpots. The lower probability of obtaining an outcome resulting in a progressive jackpot award permits the amounts in the separate progressive jackpots pool(s) to accumulate over time so that players may be attracted to play a particular machine or game in which a large progressive jackpot is available to be won. When a particular progressive jackpot is awarded to a player, the amount in that particular progressive jackpot pool is reduced to a relatively low starting value and begins to accumulate once again from the wager portions of game play contributed to that pool.

To increase the rate at which the progressive jackpot pool(s) accumulate portions of players' wagers, and therefore provide players with the opportunity to win large jackpots, a number of machines are often linked to the same progressive jackpot pools. Those machines may all be located in a single gaming establishment or may be located in more than one gaming establishment (referred to as “wide area progressives”, or “WAPs”), but regardless of their location, portions of the wagers placed at each gaming machine by players eligible to win a progressive reward are contributed to the progressive jackpot pool(s) associated with that progressive game. In some games, the opportunity for a player to participate in a progressive game is provided with every play of the game without any preconditions. In other games, the opportunity to compete for a progressive jackpot is only provided when the player's wager is above a certain level or when the player qualifies in some other manner. In some games, the opportunity to participate in a progressive game may be awarded randomly or based on one or more criteria not determined by the level of the player's wager.

The manner in which the winning outcomes for known progressive games are provided generally fall within either of two categories. The first category comprises games in which a single wager provides a player with a single play of a base game, with the outcome of that single play determining whether a progressive award is paid to the player. For example, in multi-reel slot machine games, a winning progressive outcome may comprise one particular low-probability combination of symbols appearing only on one particular payline. A second category of progressive games provide players with more than one play per wager, such as the play of a base game followed by the opportunity to play a bonus game not requiring an additional wager. The theme of a bonus game is usually different from, but often complementary to, the base game. The play of a bonus game, which in every way is the play of a second game following completion of the base game play, typically requires the player to initiate the game in some manner by pressing a “spin” button, pulling an arm or lever on the machine, or in some other manner. When a bonus game is available, one or more of the progressive jackpot(s) may only be available during play of the bonus game.

In many progressive games, the award of one of several available progressive jackpots may comprise the sole progressive award paid to a player. That is, when more than one progressive jackpot is available to be won in a particular game, only the largest single jackpot corresponding to the particular game outcome is awarded to the player and any lower-value jackpots that may also correspond to the outcome are not awarded, maintaining their value due to accumulated wager contributions over time.

Casino games are designed to provide as much excitement and allure to players as possible to encourage their continued play. While the probability of a player achieving any particular game outcome on any given play is determined by the underlying paytable, and the outcome of every electronic gaming machine (“EGM”) wagering game is determined by methods defined and approved by applicable gaming regulators and completed prior to the visual presentation of each outcome to the player, it is always desirable to provide players with an entertaining gaming experience via visual, aural, and other means generated or conveyed by the gaming machine. In practice, many different presentations of the same gaming outcome are possible, but novel methods of game outcome presentations are known to increase players' interest in, and continued play of, particular machines when compared to others with less appealing presentations. Further, when the novel game presentation is utilized to enhance the underlying game method itself, that combination results in a significant improvement over the known art in the field of progressive casino gaming.

### BRIEF DESCRIPTION OF SOME EMBODIMENTS OF THE INVENTION

Applicants have invented novel methods of providing progressive casino games with multiple reward accrual features. In particular, Applicants' methods comprise a single spin game configured to be triggered by certain gaming outcomes or paylines to automatically determine one or more progressive awards available to players by assigning progressive award valuations to certain symbols from a previous single spin outcome without the necessity of providing a second game spin, such as but not limited to one dedicated to the play of a bonus game. When a player becomes eligible to receive a progressive jackpot award based on a triggering event, the inventive game methods provide a visual display to the player during which the existing symbols from play of the base game are automatically associated with one of several available progressive jackpots with the player receiving not just the highest value progressive jackpot for which he is eligible, but the sum of all individual eligible jackpots as determined during the symbol valuation process. For example, when a single symbol or multiple symbols are included within more than one unique winning payline, the player's progressive award is comprised of the sum of each of the more than one unique payline awards.

In addition, the player also receives any non-progressive jackpots associated with the play of the base game. The inventive methods therefore provide, using only a single spin, the benefits normally available from the play of a base game plus the benefits of progressive games typically requiring more than one spin. They also provide the opportunity for players to receive multiple progressive jackpot awards instead of just receiving a single progressive award.

The separation of single-spin base game symbol determination and placement and the valuation of bonus game paylines comprising those symbols and their respective locations, via the Multiple Progressive Reward Valuation and Accrual (“MPRVA”) progressive game method described herein, is novel in the art. Not only do these methods provide advantages similar to multi-spin progressive games with only one spin and without changing symbols or re-spinning any reels, but the MPRVA game methods also allow for the independent control of the operation (and particularly the volatility) of the base game and the progressive features. The base game that provides an outcome depicted by an array of symbols, with awards based on those symbols according to the base game's paytable, serves only as the foundation for the MPRVA game features but not the determination of the specific progressive jackpot award(s). The value of those awards are established independently of the base game outcome. As will be disclosed in detail below, aspects of the progressive game may be changed to dramatically affect its volatility without any effect whatsoever on the underlying base game.

And quite notably, the methods by which (i) the progressive valuation is applied to the existing symbols and (ii) the sum of all progressive and non-progressive awards are calculated and awarded to the player provide a significant increase in the level of excitement and entertainment for players.

### BRIEF DESCRIPTION OF THE DRAWINGS

Without limiting the invention to the features and embodiments depicted, certain aspects this disclosure, including the preferred embodiment, are described in association with the appended figures in which;

FIG. 1 depicts a typical primary game EGM presentation to a player prior to play of a game;

FIG. 2 depicts a typical secondary game EGM presentation to a player displaying the information regarding the first, second, third, and fourth level progressive jackpots available to be won;

FIG. 3 depicts the primary game EGM presentation to a player displaying the outcome of a first game play when the game outcome is eligible for evaluation to award one or more progressive jackpot awards;

FIG. 4 depicts the primary game EGM presentation to a player displaying a first stage of progressive award evaluation of the first game play outcome and a potential progressive award symbol at a first level;

FIG. 5 depicts the primary game EGM presentation to a player displaying a second stage of progressive award evaluation of the first game play outcome where no progressive award was provided to the player;

FIG. 6 depicts the primary game EGM presentation to a player displaying a third stage of automatic progressive award evaluation of the first game play outcome and a potential progressive award symbol at a first level;

FIG. 7 depicts the payline corresponding to the first progressive award comprising the symbol valuation resulting from the first stage of progressive award evaluation;

FIG. 8 depicts the payline corresponding to the second progressive award comprising the symbol valuation resulting from the third stage of progressive award evaluation;

FIG. 9 depicts the secondary game EGM presentation displaying the total of the progressive jackpots awarded to a player from the first and third stages of progressive award valuation;

FIGS. 10-12 depict examples of some the non-progressive paylines for which additional credits have been awarded to the player in addition to the progressive awards and the total win value resulting from the winning progressive and non-progressive paylines;

FIG. 13 depicts the primary EGM presentation in a different instance of the game showing the availability of an award at a second level;

FIG. 14 depicts the primary EGM presentation in a different instance of the game showing the availability of an award at a third level;

FIG. 15 depicts the primary EGM presentation in a different instance of the game showing the availability of an award at a fourth level;

FIG. 16 depicts the secondary EGM presentation showing incremented values of the various progressive jackpots available to be won;

FIG. 17 depicts the secondary game EGM presentation displaying the total of the progressive jackpots awarded to a player from the incremented and reset value of the first level of progressive award valuation;

FIG. 18 depicts the secondary EGM presentation showing incremented values and reset values of the various progressive jackpots available to be won;

FIG. 19 depicts the outcome of a primary game showing eligibility for a progressive award in another embodiment of the invention;

FIG. 20 depicts the bonus paylines eligible for a progressive award resulting from the primary base game spin in this embodiment of the invention;

FIGS. 21-27 depict the progressive bonus award selection process for a first eligible symbol resulting from the primary base game spin in this embodiment of the invention;

FIGS. 28-33 depict the progressive bonus award selection process for a second eligible symbol resulting from the primary base game spin in this embodiment of the invention;

FIGS. 34-35 depict progressive bonus paylines including the bonus award levels resulting from the primary base game spin in this embodiment of the invention;

FIG. 36 depicts the selected progressive bonus awards as overlay frames surrounding the symbols selected during the primary base game spin in this embodiment of the invention;

FIGS. 37-40 depict the various paylines and the amount awarded for each, also including the total accrued win total for the bonus game resulting from the primary base game spin in this embodiment of the invention; and

FIG. 41 depicts the progressive jackpot award associated with each award level in this embodiment of the invention.

### DETAILED DESCRIPTION OF SOME EMBODIMENTS OF THE INVENTION

In one embodiment, the MPRVA game method is provided by one or more electronic gaming machine(s) (“EGMs”) comprising at least (i) one or more processor(s), (ii) one or more memories comprising at least one of any of random access, static, flash, permanent, erasable, programmable, read-only, or other memory, (iii) physical, electronic, or physical and electronic access to one or more local or remote data storage devices comprising some combination of electronic, magnetic, and optical memory, (iv) at least one but preferably more than one visual display of any known or later developed technology, (v) one or more peripheral devices, including but not limited to one or more button(s), keypad(s), or touchscreen capability embedded in said visual display(s) for providing player input to the EGM, (vi) one more wired or wireless communication ports or interfaces including but not limited to TCP/IP, those associated with any Gaming Standards Association (“GSA”) communication protocols, USB®, SAS®, any known or later developed wireless protocol including IEEE 802.11®, Wi-Fi®, BlueTooth®, ZigBee®, and the like, and (vii) one or more peripherals configured to accept gaming wagers and provide payouts to players in coin, currency, token, gaming ticket, electronic, or any other useful form.

The wager-based elect EGM is well known in the art and offers players an opportunity to place a wager using cash or a cash equivalent in return for an opportunity to receive a cash or cash equivalent award calculated according to posted odds based on a random gaming outcome. EGMs are highly specialized computing and electromechanical devices comprising sophisticated anti-tampering and fraud monitoring devices with comprehensive security means embedded throughout each of the EGM's various subsystems to ensure operation of the machine in a manner consistent with the design of the game(s) it is configured to provide in compliance with all applicable gaming laws and regulations of the jurisdiction in which it is licensed. Due to the fact that EGMs may accept and dispense large quantities of cash or cash equivalents, security is paramount in their design and operation. Although EGMs comprise certain components common to conventional computing components, such as processors, memories, and displays, it should not be construed in any manner as a conventional computing device since it is clearly not configured to perform, and is incapable of performing, many of the routine data manipulation tasks for which conventional computing devices have become ubiquitous. Instead, an EGM is a specifically selected combination of hardware components configured to perform very high-level specialized functions and only a limited subset of conventional computing tasks as a necessary component of its specialized and highly secured wagering game operation. The considerably higher operational standards imposed upon EGMs clearly exceed the scope of conventional computing devices and confers subject matter eligibility upon the EGM and its associated hardware, firmware, and software, including the system and methods disclosed herein.

While the MPRVA methods may be presented in a wide variety of specific embodiments, the following description is provided for illustrative purposes and is not intended to be limiting upon the scope of the disclosure in any manner. The novel features of the inventive methods are best understood via a step-by-step analysis of several progressive casino game embodiments and additional examples provided below. A person of ordinary skill in the art will recognize that the same methods may be embodied in other specific game presentations to provide the same advantages over the known art.

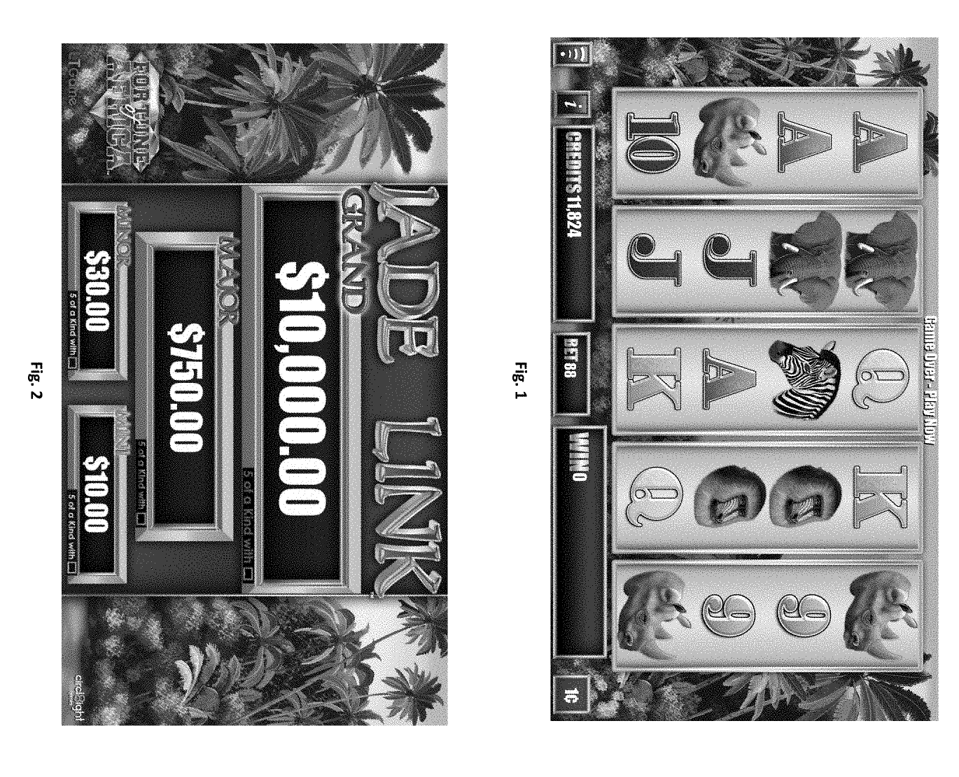

FIG. 1 presents the state of the primary game display prior to the play of a first MPRVA game. The display comprises five reels (columns) with four rows visible to the player, resulting in an array of twenty symbols. Various paylines are defined in the paytable (not shown) comprising not more than one symbol from each column (reel) from two or more reels. Paylines defined in the paytable may include horizontal rows or portions of horizontal rows, each of the two principal diagonals or portions thereof, and a myriad of other combinations each comprising two or more symbols. Not every combination of symbols necessarily comprises a payline; to do so would ensure that every game play resulted in a winning outcome for the player and the game economics would not be viable for the casino operator. Due to the irregular nature of some paylines in games comprising a multitude of paylines, it may be difficult for a player to identify which symbol combinations are paylines and which are not. It is therefore beneficial for a multi-payline game to identify any winning paylines to the player at the conclusion of each game. The paylines may be defined as desired by the game developer and are not limiting upon the scope of the MPRVA methods. In other words, this invention is not dependent in any way on the definition of any specific payline or paylines and, as described below, may be configured to operate using any particular outcome(s), payline(s), or other symbol combination(s) as the trigger to evaluate that outcome for progressive award(s).

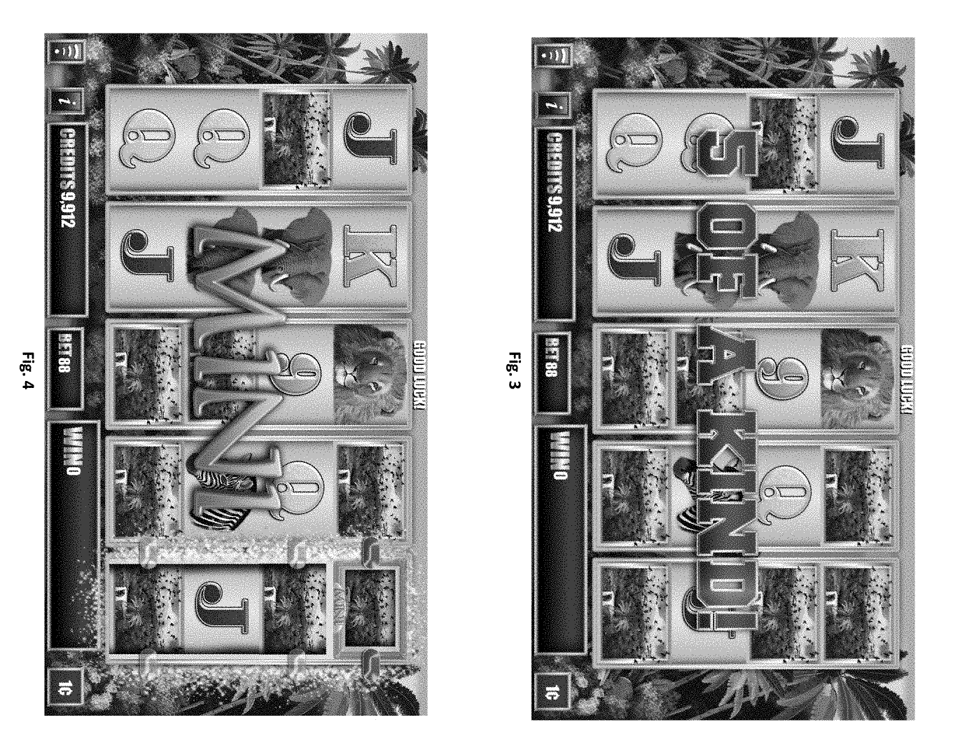

FIG. 2 depicts a secondary game presentation comprising information about the various progressive awards available to be won in this embodiment. The secondary game presentation may be displayed on the same physical display as the primary game display, but in some embodiments the secondary game presentation is preferably displayed on a separate physical display, such as but not limited to the “top box” or other peripheral display device on an EGM. In this embodiment, four progressive bonus jackpot awards are available at each of the “MINI” level ($10.00), the “MINOR” level ($30.00), the “MAJOR” level ($750.00), and the “GRAND” level ($10,000.00). As discussed above, the odds of a player receiving the smallest (“MINI”) level progressive jackpot are much greater than the odds of receiving the largest (“GRAND”) jackpot so that many more “MINI” awards are won than are any of the other three. However, the probability of receiving any of the progressive jackpot awards is generally much less than the probability of receiving an award from play of the non-progressive base game, but the relative win probabilities may be established in any manner desired by the game designer.

FIG. 3 depicts the results of a base game outcome displayed to a player after a wager is placed and all five reels are spun and have come to rest. The MPRVA feature is triggered by particular payline(s) or outcome(s) selected by the game designer. In some embodiments, the MPRVA feature may be triggered by particular symbols and their respective positions, such as in a pre-defined payline. In this embodiment, the MPRVA feature is triggered by the presence of at least one payline comprising “five-of-a-kind” symbols (natural or “wild” symbols) as displayed to the player in this figure. As will be seen and explained below, this particular twenty symbol outcome comprises three distinct five-of-a-kind paylines that will each be evaluated for progressive awards. Each of the payline(s) that trigger the MPRVA bonus game feature will be eligible to receive a bonus award based on the jackpot level assigned to the symbol in a specially designated position as described below.

Other embodiments may, as desired, utilize triggers other than a “five-of-a-kind” payline described above. By way of example and not limitation, in one embodiment the MPRVA feature may be triggered by a certain number of identical symbols within the view of a player on a multiple reels not necessarily on a single payline or in other prescribed positions. In the case of the five column, four row, twenty symbol array representing the outcome of a single game play shown in FIG. 3, the display of any five identical symbols in any position on any of the reels may be specified to trigger the bonus, such as two of the five identical symbols visible on reel land three of the five identical symbols visible on reel 2. In one embodiment, the number of identical symbols in the symbol array outcome required to trigger the MPRVA feature may be any desired number from two to the maximum number of symbols within the symbol array visible to the player. Triggering of the MPRVA feature is clearly not limited to the use of identical symbols in the various embodiments. For example, it may be triggered by one or more certain payline combination of non-identical symbols in a specified order or in any order. In some embodiments as described above, the non-identical symbol combinations may be required to be on a single payline or the symbols may be scattered anywhere with the visible gaming outcome displayed by the symbol array. In one embodiment, the presence of a single designated symbol, particularly but not exclusively comprising a symbol dedicated solely to triggering the MPRVA feature, appearing anywhere within the outcome symbol array may be used to trigger the MPRVA feature. Multiple such symbols may also be used. Further, these symbols may or may not have any value within the base game for use in determining winning paylines and may only be useful for triggering the MPRVA feature. The selection of the outcome(s) or payline(s) that trigger the MPRVA bonus game feature are determined by the game designer in advance of play of the primary game.

From the disclosure above, a person of ordinary skill in the art will appreciate that the number of ways in which the MPRVA feature may be triggered is practically unlimited and is constrained only by the imagination and at the discretion of the game designer.

Bonus jackpot awards are determined by assigning a jackpot level to the symbols occupying certain positions defined by the game designer. In the particular embodiment being described, the payline symbol positions on the fifth (right-most) reel have been selected by the game designer for progressive award valuation during the MPRVA bonus game. In this embodiment, every symbol within at least one five-of-a-kind payline that appears in this fifth pseudo-reel column will be associated with a progressive bonus jackpot level for the purpose of determining the award(s) to be paid to the player. In other embodiments, symbols from one or more different reels may be used, symbols may be selected at random, or particular symbols may be selected regardless of the column, row, or payline in which they appear consistent with the particular progressive award trigger used. In some embodiments, any other selection criteria desired by the game designer may be utilized without limitation. The selection of the position(s) of symbols to be associated with progressive game bonus jackpot levels are also determined by the game designer in advance of play of the primary game.

The progressive jackpot award process comprises two steps. First, symbols in the selected positions of each payline are assigned a value upon which a progressive jackpot will be based. In this embodiment, each of the symbols on the fifth (right-most) reel which are included in any “five-of-a-kind” payline are sequentially evaluated for a progressive award using a spinning pseudo-reel overlay comprising frames of separate colors or other distinctive markings corresponding to the four progressive awards described above as available in the game of this embodiment. The symbols resulting from the base game spin are fixed and do not change during this process. Instead, for each symbol on the fifth reel that is a part of a “five-of-a-kind” payline, one such symbol is designated at a time and a pseudo-reel comprising overlays of blank frames, frames corresponding to the first (“MINI”) level, frames corresponding to the second (“MINOR”) level, frames corresponding to the third (“MAJOR”) level, and frames corresponding to the fourth (“GRAND”) level are spun over the entire column of fixed symbols, eventually coming to rest. At rest, the designated symbol will be enclosed by one of the four frames corresponding to the four progressive awards or enclosed by a blank frame. The particular frame or lack of a frame around each symbol will determine whether the one or more payline(s) comprising that symbol result in the awarding of a progressive jackpot to the player as a result of that single game play. The pseudo-reel of frame overlays is spun separately for each symbol on the fifth reel (column) that is part of a “five-of-a-kind” payline.

The second step in the progressive jackpot award process is to calculate, and then add together, the awards associated with each of the paylines comprising a symbol to which a particular jackpot level has been assigned by virtue of the frame overlay assigned to it in the previous step.

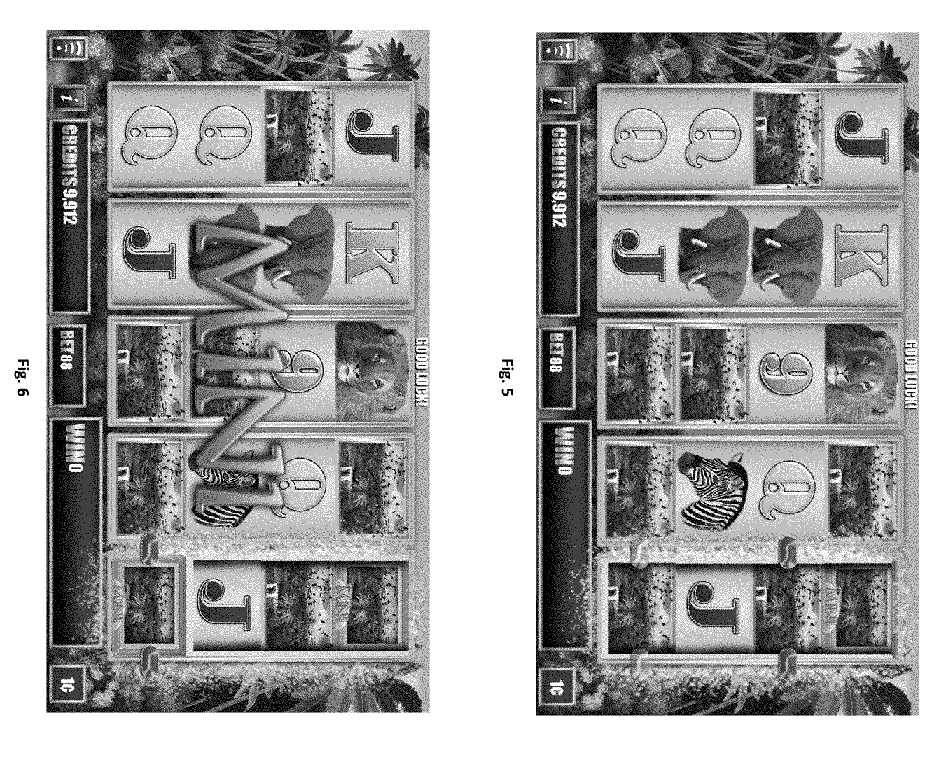

In the play of this particular game, FIG. 4 shows that the “wild” symbol comprising an African landscape on the fifth reel, uppermost position (first row) is designated by two oval beads on either side of the symbol and the frame pseudo-reel overlay has been spun, resulting in a frame corresponding to the “MINI” progressive jackpot coming to rest over the designated symbol. This frame is affixed to that symbol for use in the subsequent step of calculating and awarding progressing jackpots.

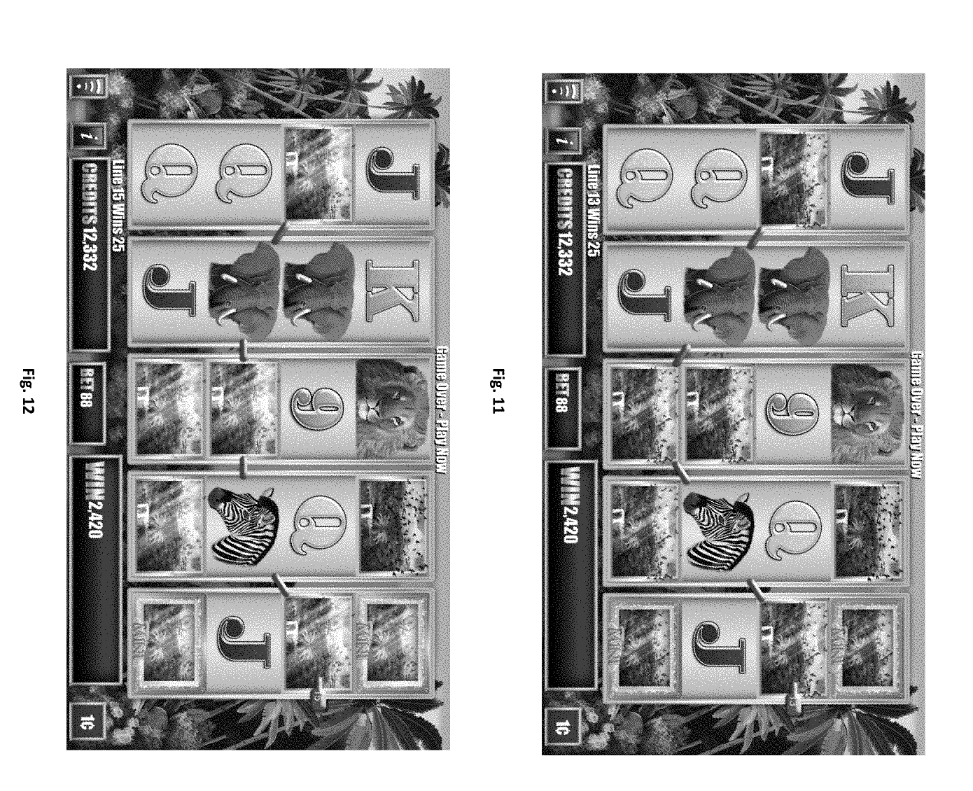

In FIG. 5, the reel 5 symbol in the second row is subsequently designated by the oval beads and the frame overlay pseudo-reel spun again for this particular symbol, this time resulting in a blank frame coming to rest over the symbol. Even though this symbol was part of at least one “five-of-a-kind” payline, the fact that none of the four progressive jackpot frames have been associated with this symbol means that no paylines comprising this symbol will result in the awarding of a progressive jackpot. However, as seen and described below with respect to FIGS. 10 and 11, this “wild” symbol is still eligible for use in calculating and awarding non-progressive payouts to the player.

The reel 5 symbol in the third row (“J”) was not included in any “five-of-a-kind” paylines of the base game, so the frame overlay pseudo-reel was not spun to associate a progressive or blank frame with that symbol.

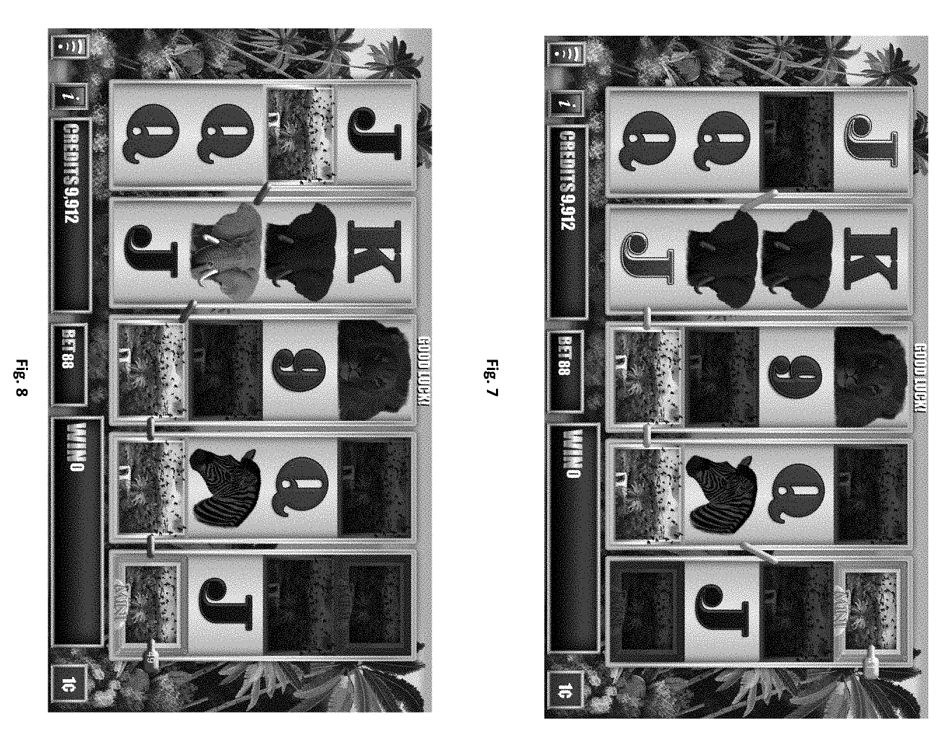

In FIG. 6, the reel 5 symbol in the fourth (lowermost) row is now designated by the oval beads and the frame pseudo-reel overlay is spun a third time. This time, the “MINI” frame comes to rest over the designated symbol and the frame is affixed thereto. This progressive valuation of each pertinent symbol (in rows 1, 2, and 4) of the fifth reel completes the first part of the two-step progressive award determination process.

Notwithstanding the particular method steps of the exemplary embodiment being described, the progressive award valuation of each qualifying symbol may be performed in any number of different ways. As examples without limitation, a single spin of the frame overlay pseudo-reel may be used to assign a progressive award valuation to each of the eligible symbols. In one embodiment, placement of the frames separately superimposed on each of the eligible symbols when the pseudo-reel comes to rest may be assigned to each of the associated symbols. In one embodiment, one of the frames superimposed over any of the eligible symbols may be assigned to all of the symbols, particularly but not exclusively the frame which provides the highest potential progressive award for the player. In the case where each symbol in an entire column (such as all four symbols on the fifth and rightmost reel of FIG. 6) is eligible for valuation, the entire column of symbols would then be associated with the same frame for progressive valuation purposes. This would increase the volatility of the game tremendously, particularly when the highest-valued frame superimposed over any eligible symbol is applied to all of the eligible symbols.

In one embodiment described more fully below, a virtual single frame overlay may be spun over each symbol to be evaluated for progressive award valuation in lieu of spinning a pseudo reel overlay over the entire column of fixed symbols.

In some embodiments, the odds of a player receiving any particular valuation of the eligible symbols may be determined by any of a number of different methods. In one embodiment, the assignment of symbol valuations awarded by the spinning of a frame overlay pseudo-reel are independently random; each spin produces a random result from the frame symbols assigned using a pre-determined pseudo-reel configuration. In one embodiment, the probability of a player receiving a certain valuation for a particular symbol may be wholly or partially dependent on the result(s) of previous spin(s) of the frame overlay pseudo-reel. As a non-limiting example, when a player receives a particular valuation (frame) for a first symbol, all instances of that frame may be removed from the frame overlay pseudo-reel for subsequent spins. If a removed non-blank frame is replaced by a blank frame, the volatility of the progressive reward process is reduced because the next spin of the frame overlay pseudo-reel is more likely to result in a blank frame for subsequent spin(s). However, if a removed non-blank frame is replaced by a non-blank frame associated with a higher progressive reward, the volatility would be increased because that preferred frame is more likely to be selected than prior to the replacement. If a blank frame is replaced by a non-blank frame, the volatility will similarly increase for the same reason. Accordingly, whenever the frame overlay pseudo-reel is altered as a result of the results of a previous valuation spin, the volatility of the progressive aspects of the game can be changed in either direction. This additional measure of flexible progressive volatility is also novel over all known art.

The MPRVA game method continues to a second step where any progressive awards displayed by the single-spin outcome and valued by any of the method steps above are calculated and paid to the player. The progressive paylines are determined solely by the primary base game symbols themselves, while the value of the progressive awards attached to each of those progressive paylines is determined solely by the valuation step described above. The separation of symbol determination via the single-spin game play and the valuation of paylines comprising those symbols, via the MPRVA methods, is also novel in the art.

In this embodiment, each progressive award payline must comprise one symbol from the fifth reel associated with a frame corresponding to one of the four available awards. In FIG. 7, the “five-of-a-kind” payline comprising the “MINI” progressive jackpot symbol in the first row of the fifth reel is displayed. This payline consists of the “J” symbol on reel 1, row 1, the “J” symbol on reel 2, row 4, the “wild” symbols on reels 3 and 4, row 4, and the “wild” symbol enclosed by the “MINI” frame on reel 5, row 1. No other “five-of-a-kind” payline in this game outcome includes this symbol on reel 5, row 1, so only one progressive award is provided to the player based on this symbol. If there had been other “five-of-a-kind” paylines comprising this symbol but also comprising at least one different symbol from any column, those awards would have been added to the single progressive award derived from this outcome. An example of this condition is provided below.

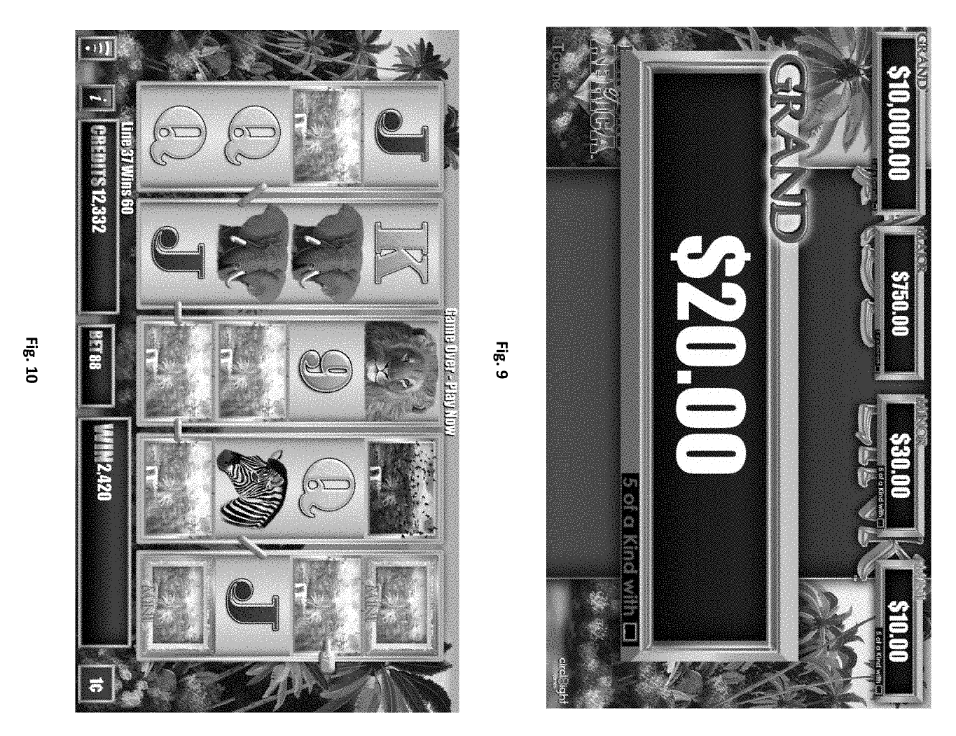

In FIG. 8, the “five-of-a-kind” payline comprising the “MINI” progressive jackpot symbol in the fourth row of the fifth reel is displayed. This payline consists of the “wild” symbol on reel 1, row 2, the “elephant” symbol on reel 2, row 3, and the three “wild” symbols on reels 3, 4, and 5, row 4, with the latter “wild” symbol enclosed by the “MINI” frame on reel 5, row 4. These two are the only “five-of-a-kind” paylines comprising symbols associated with any of the progressive award frames placed during the first step of the progressive award process.

Returning to FIG. 2, it can be seen that the value of each “MINI” progressive jackpot award at the time of the single game spin was $10.00. Because there were two “five-of-a-kind” paylines comprising symbols with the “MINI” designation, and because each such paylines receives a $10.00 award, the player is awarded a total progressive jackpot award of $20.00 (2,000 credits for the game denomination of 1 cent per credit) for the play of this one game. FIG. 9 shows secondary display and the value of the player's progressive award.

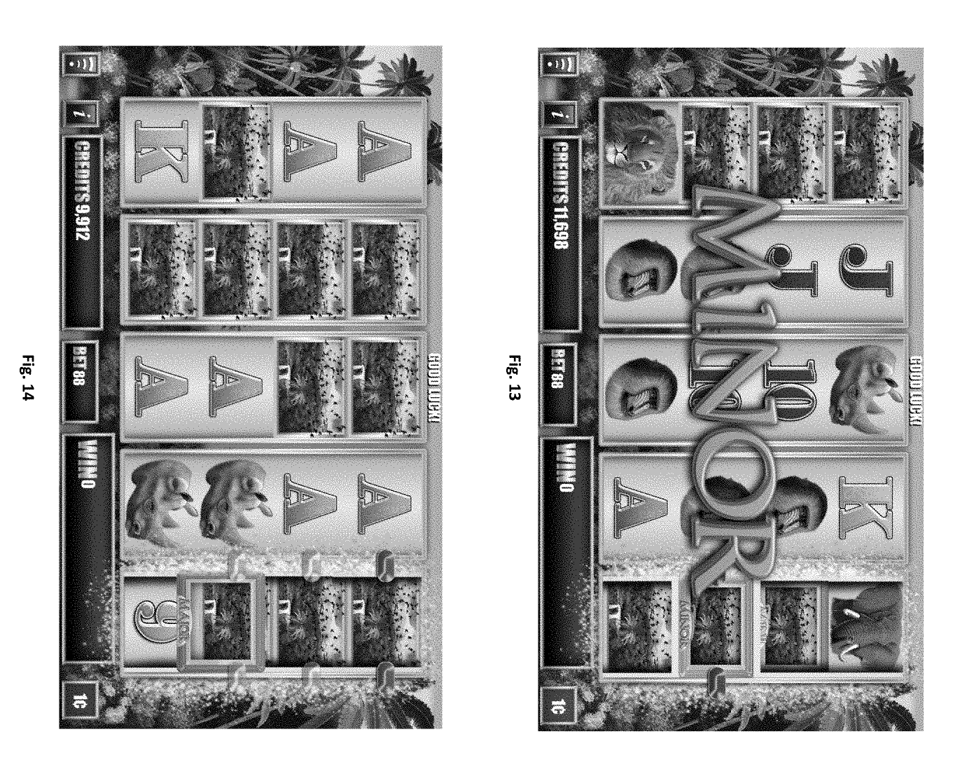

In addition to the player's total progressive award in this game, he is also awarded the sum of the payouts corresponding any winning non-progressive paylines as defined in the primary base game's paytable. FIGS. 10 through 12 present several representative examples of the winning non-progressive paylines present in the original single-spin game. For example, and as shown, the payline shown in FIG. 10 provided a win of 60 credits, the payline of FIG. 11 provided a win of 25 credits, and the payline of FIG. 12 provided an additional win of 25 credits. The remainder of the non-progressive paylines are not shown. Each of these three figures also show that the player's total win for this one game play was a total of 2,420 credits; 2,000 of these credits were derived from the two progressive jackpot wins ($20.00 total) and the remaining 420 credits ($4.20) are attributable to the non-progressive awards including the examples of FIGS. 10-12. Note that the “wild” symbol on reel 5, row 2 was used to calculate the non-progressive awards in FIGS. 11 and 12 even though it was not available for a progressive award based on the earlier assignment of a blank frame to that symbol.

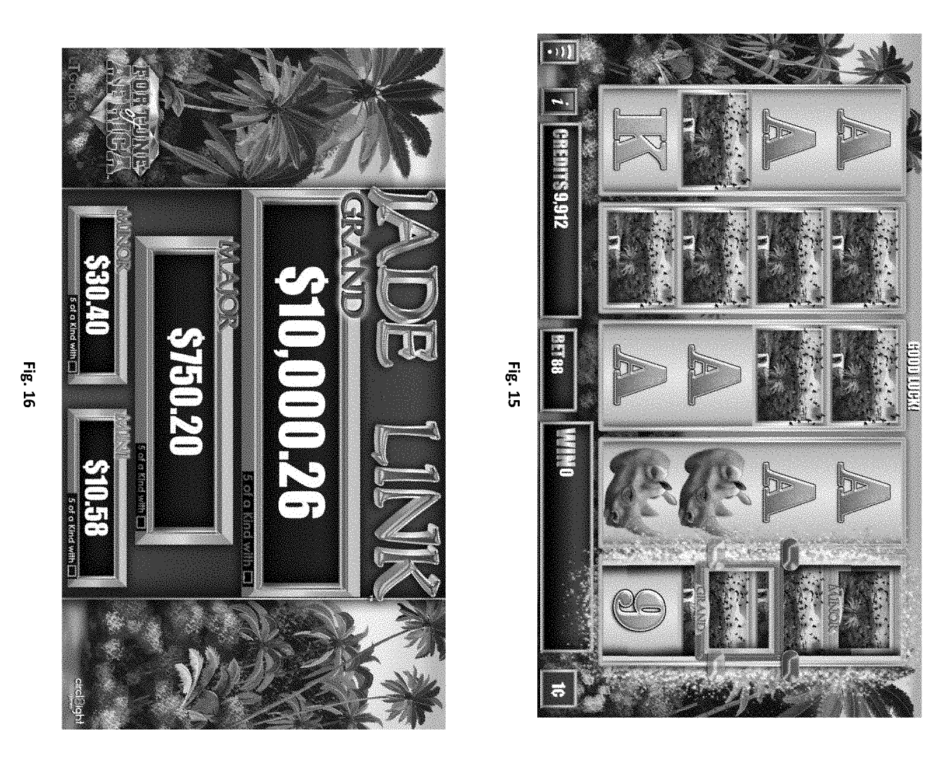

Although the outcome of this particular instance of a MPRVA game resulted in only the first level of progressive awards (“MINI”) being assigned, this embodiment of the method provides opportunities for players to receive progressive awards at the three other levels as well. For example, during the play of another instance of the MPRVA bonus game of this embodiment, FIG. 13 depicts the frame associated with a second level “MINOR” designation frame moving across the reel 5 symbol in row 2 during a spin of the frame overlay pseudo-reel. Similarly, FIG. 14 shows the third level “MAJOR” frame overlay moving down the fifth reel between rows 3 and 4. Finally, FIG. 15 shows the fourth and highest value (“GRAND”) frame overlay moving between the second and third rows as the pseudo-reel continues to spin.

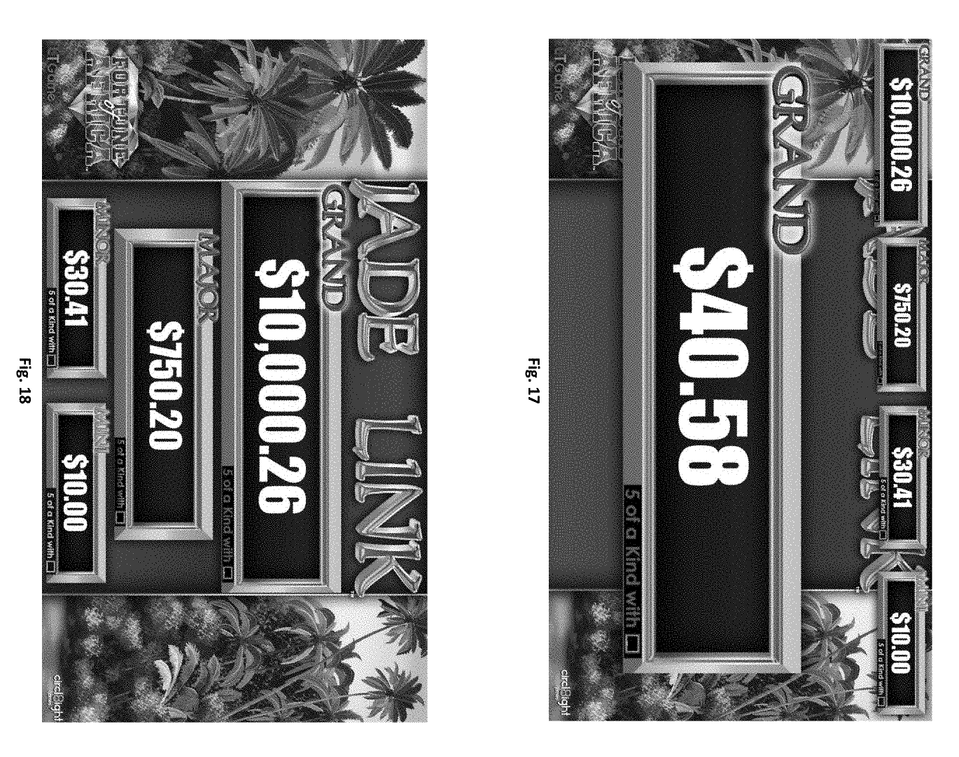

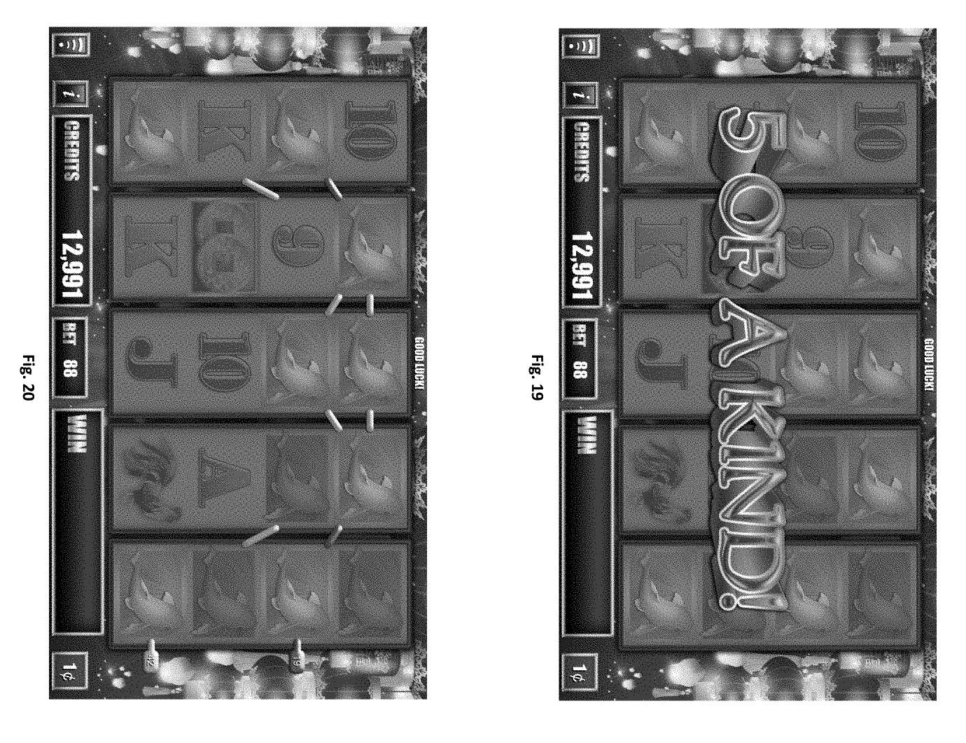

FIGS. 16 -18 illustrate the progressive nature of the four jackpots. After a limited number of game plays, FIG. 16 depicts the slightly increased value of each of the four progressive jackpot pools shown on the secondary display as a result of portions of the game play wagers being contributed to each jackpot pool. In FIG. 17, a total progressive jackpot award of 4 “MINI” progressive jackpots (attributable to four progressive paylines in a single game) is shown. The progressive award value of $40.58 is comprised of a first award of the previously-accumulated “MINI” jackpot value of $10.58 from FIG. 16, followed by three additional awards of $10.00 each after the “MINI” jackpot was reset to its original value of $10.00 after the first award was paid. Finally, in FIG. 18, the secondary display reveals that the “MINI” jackpot has indeed been reduced to its starting value following these awards but that the other three jackpot pools, yet to be awarded, retain their accumulated value.

In one embodiment, a virtual single frame overlay may be independently and sequentially spun over each symbol eligible to be evaluated for progressive award valuation in lieu of spinning a pseudo reel overlay over the entire column of fixed symbols at once. As in the previous embodiment, the payline symbols on the fifth (right-most) reel are used in this embodiment for progressive award valuation. As described before, and in other embodiments, symbols and their positions from one or more different reels may be used for the purpose of bonus triggering or award calculation. Symbols may be selected at random, or particular symbols may be selected regardless of the column, row, or payline in which they appear consistent with, or in contrast to, the particular progressive award trigger used. Aside from the different game theme and symbols, the difference between this embodiment and the one previously described and shown in the drawings is in the graphical depiction provided to the user to display the selection of progressive bonus levels assigned to each of the eligible symbols of the pre-determined outcome. A person of ordinary skill in the art will appreciate that any other means of depicting the selection of progressive bonus preferred by the game designer is also within the scope of this disclosure which is not limited to just the disclosed embodiments.

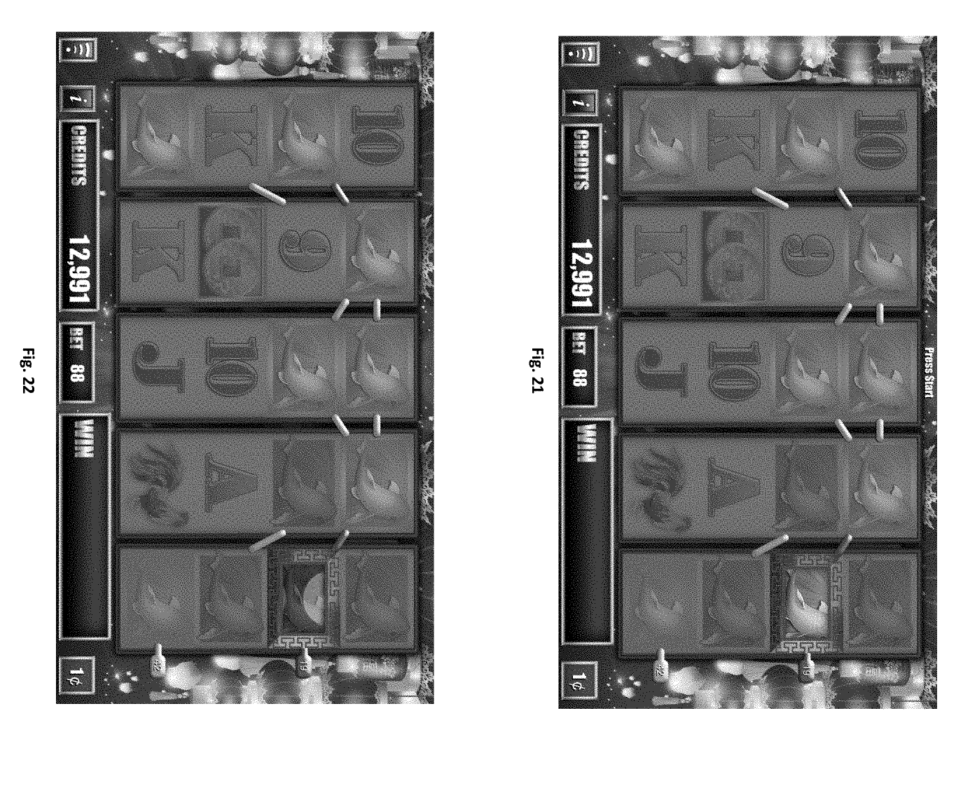

FIG. 19 presents the display of a five reel four row electronic gaming machine after the machine has generated (as a Class III machine) or received from a central server (for a Class II machine) a primary game outcome and displayed its corresponding graphical depiction, this outcome comprising two symbols on reel 5 (the right-most column) to be used for progressive bonus awards. The respective positions of the multiple koi symbols appearing in the outcome display array correspond to three five-of-a-kind bonus award outcomes to be paid following evaluation of the two koi symbols in the fifth column (rows 2 and 4). FIG. 20 depicts these paylines using connector links of three different colors. Note that the koi symbol on reel five, row 2 is an element of two separate paylines designated by the pink and green connector links shown.

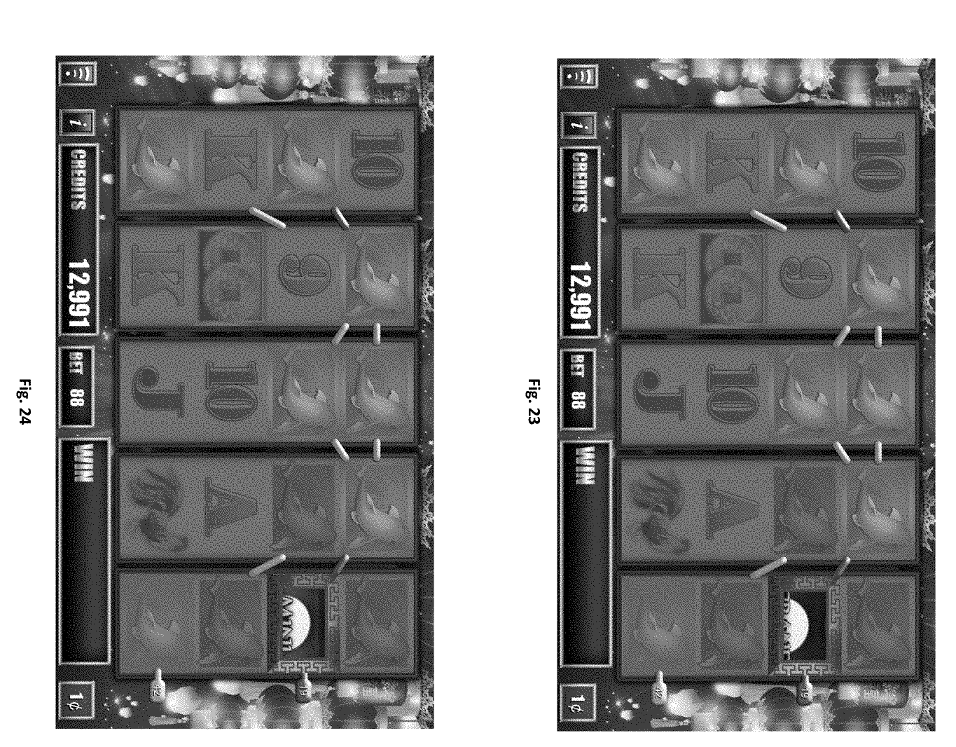

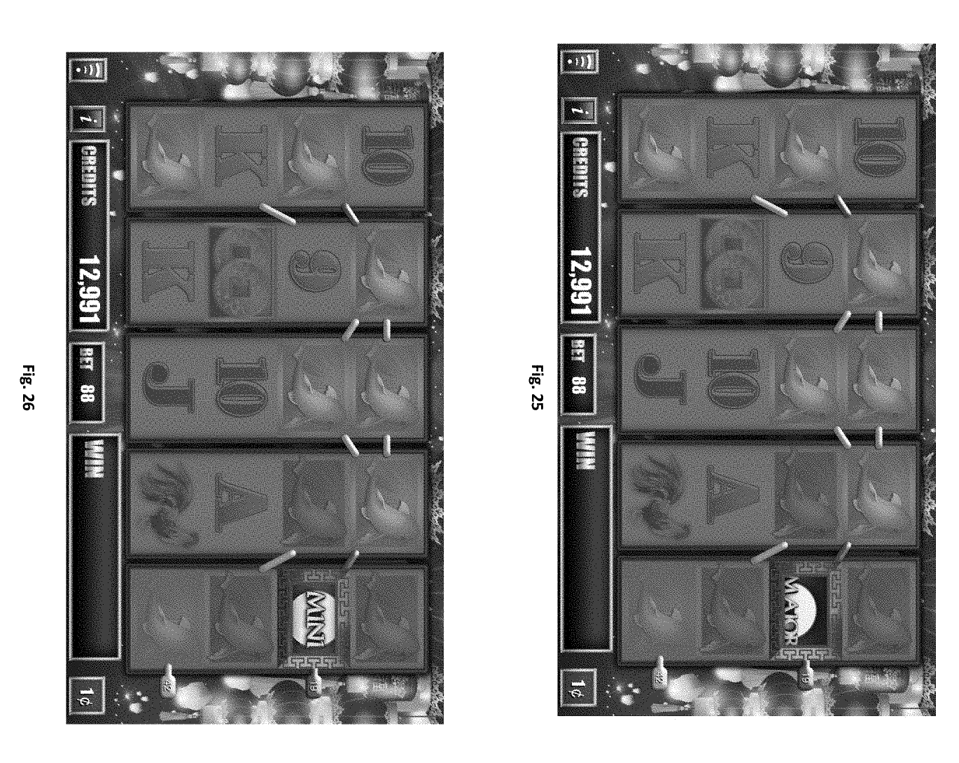

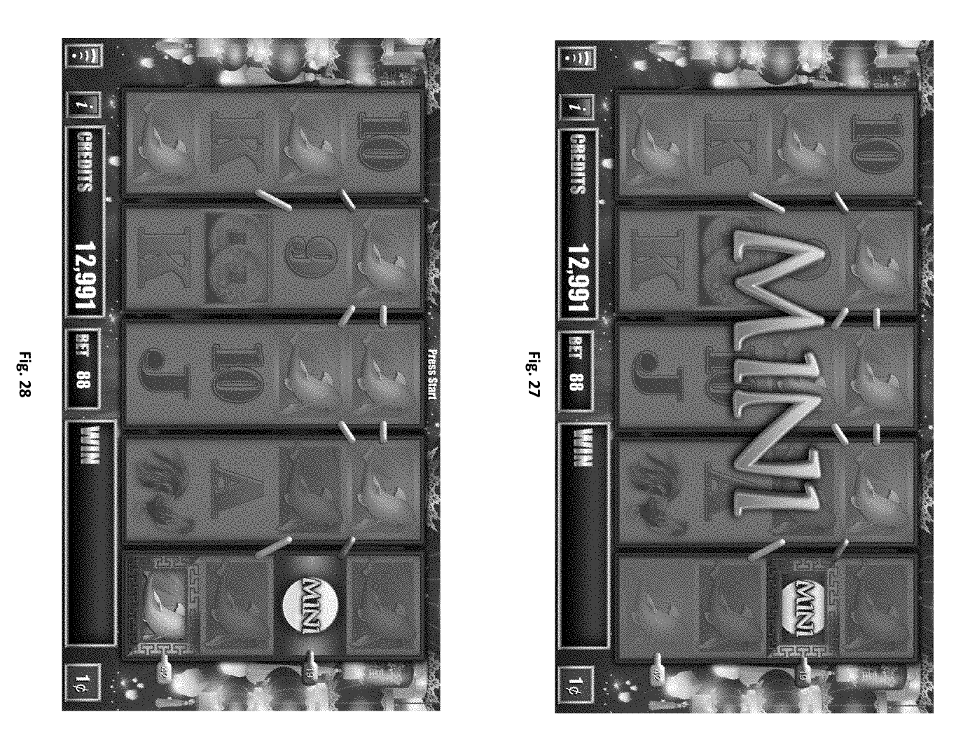

The progressive bonus award valuation process for the symbol in column 5, row 2 is shown in FIGS. 21-27. Beginning with FIG. 22, the virtual single frame overlay is spun in place of the underlying koi symbol without changing the ultimate placement of that symbol; it is a principal feature of this gaming system that none of the primary base game symbols or their placements are modified during play of the progressive bonus game The overlay merely supplants the display of the underlying symbol during display of the progressive bonus award process. FIGS. 23-26 show the possible bonus valuation outcomes scrolling past, revealing the possible outcomes as being any one of the MINI, MINOR, MAJOR, or GRAND levels. In FIG. 27, the MINI valuation has been designated and displayed in accordance with the pre-determined gaming outcome.

As before, the progressive award value for each level varies is established and is incremented at least in part with respect to the probability of receiving such awards and the MPRVA paytable designated by the game designer; the values applicable during play of the example game of this embodiment are presented in FIG. 41. As explained above, portions of players' wagers are contributed to each of the progressive jackpots to increment the various jackpot award values. The amount of these wager contributions, the initial value of the awards, the rate at which these jackpots are incremented from said contributions, and the frequency at which the various jackpots are awarded is infinitely variable and subject to the designer's preference in crafting a game that will maximize player interest and comport with the financial requirements of the game operator and the WAP provider.

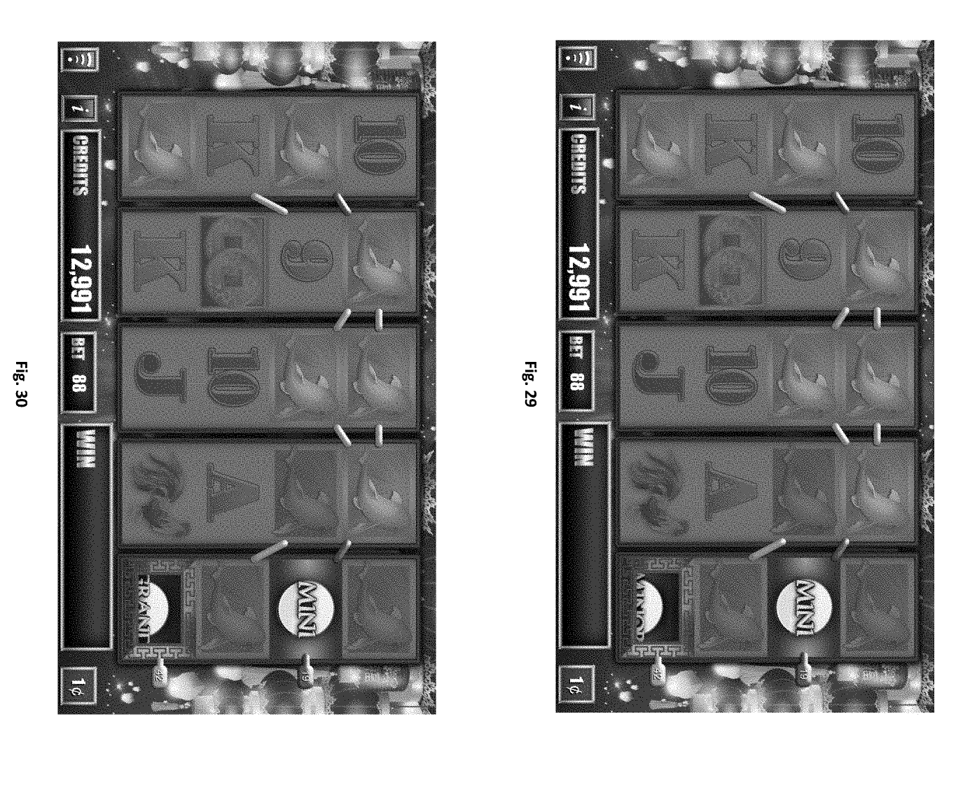

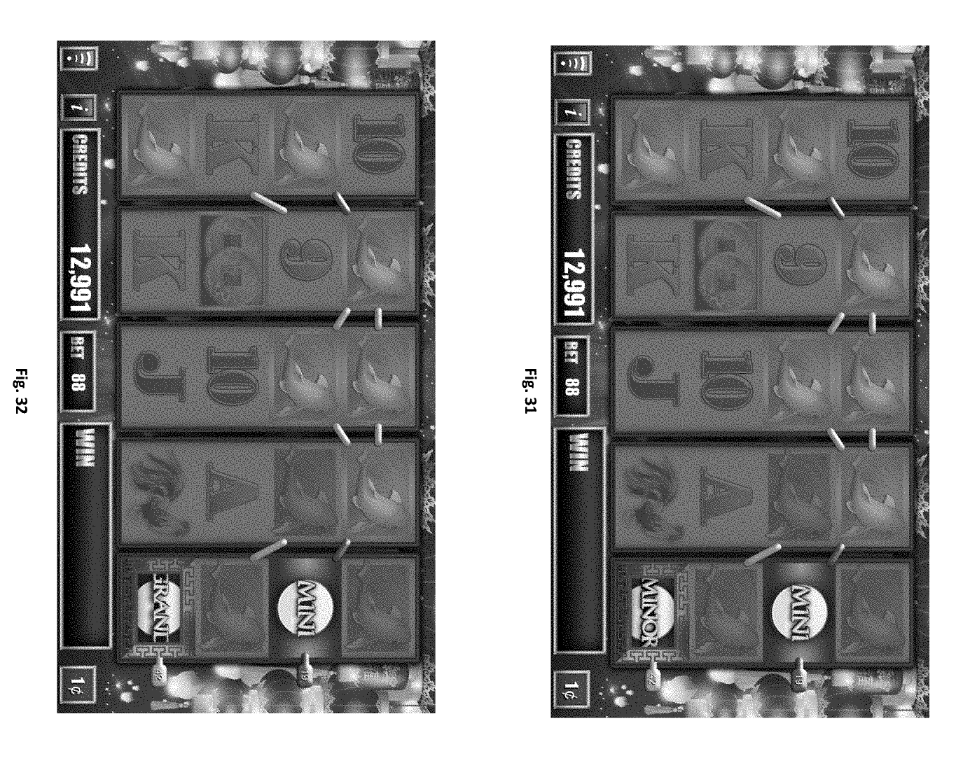

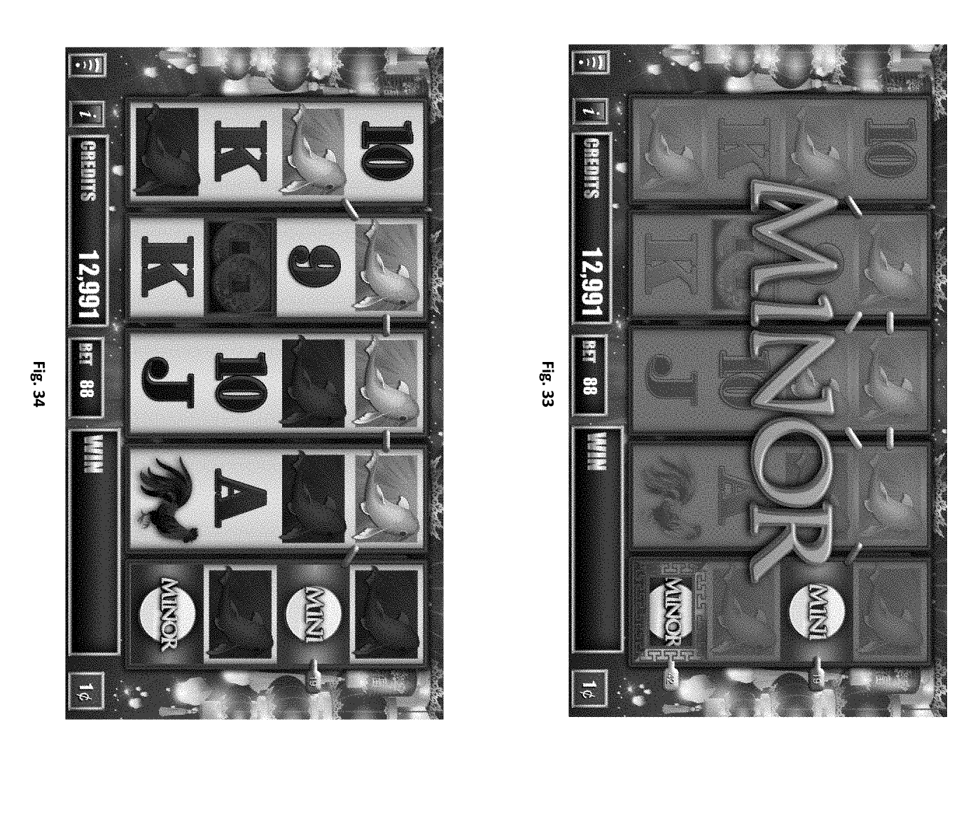

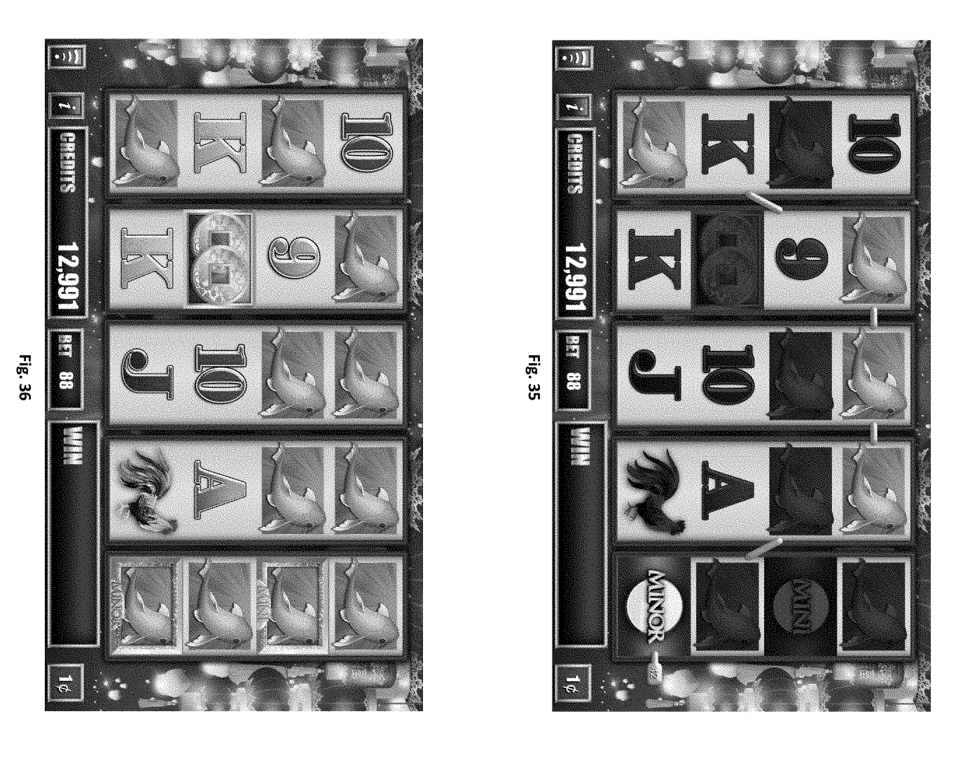

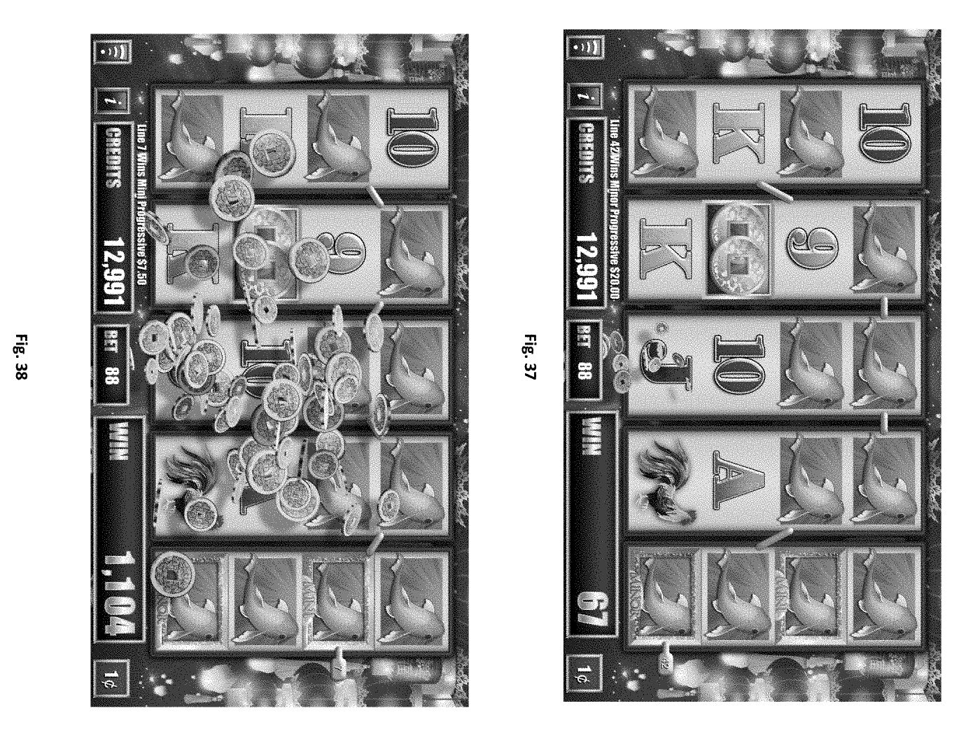

Next, the bonus symbol valuation process is repeated for the second koi symbol in column 5, at row 4 as shown in FIG. 28. FIGS. 29-32 show several of the possible outcomes scrolling past until the final valuation, a MINOR award, settles in this position as shown in FIG. 33. The color connectors of FIGS. 34 and 35 show two of the five-of-a-kind paylines subject to a progressive bonus award according to the award levels just selected (MINI and MINOR, respectively). In FIG. 36, the MINI and MINOR valuations as selected are depicted as frames surrounding the original koi symbols revealed once again just as they were placed during the original primary game spin.

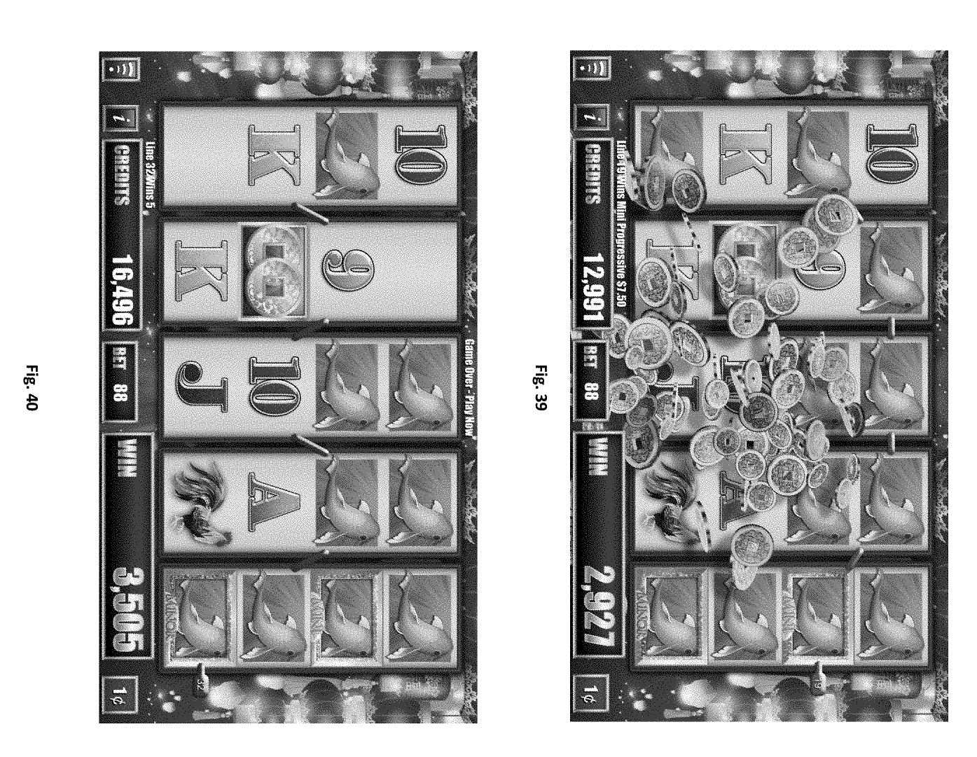

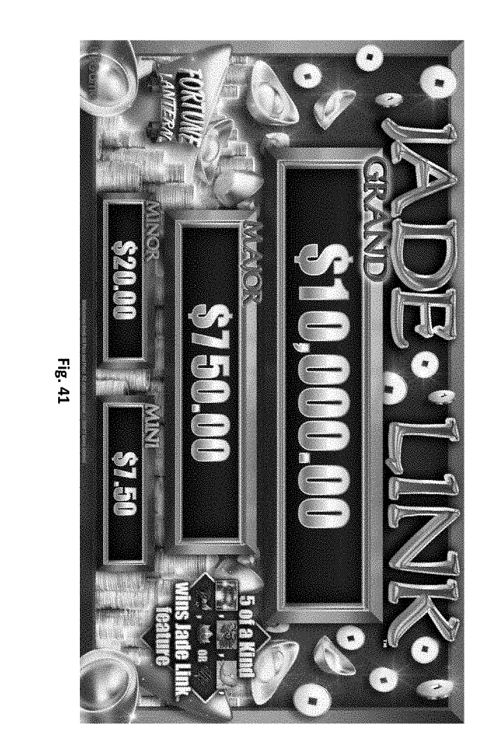

FIGS. 37-40 depict each of the paylines and their respective award values that are summed to produce the total payout to the player. The “Win” counter is incremented over a period of time in an “attract mode” while the winning paylines are cyclically repeated, a splash display of gold coins partially obscures the symbol array as the contributing paylines are shown, and the player's total winnings are seen to accumulate in each of the following drawings. In this embodiment, each credit represents $0.01 (one cent). In FIG. 37, payline 42 accrues a MINOR progressive bonus payout of $20.00. In FIG. 38, payline 7 accrues a MINI progressive bonus payout of $7.50. In FIG. 39, payline 19 also accrues a MINI Progressive payout of 7.50. Note that paylines 7 and 19 each comprise the koi symbol on reel 5, second row, and its assigned MINI progressive bonus level jackpot award status. Finally, in FIG. 40, payline 32 accrues a non-progressive bonus payout of $0.05. As shown in FIG. 40, the total bonus game payout (“Win”) comprises the sum of all awards; progressive bonus payouts for lines 42, 7, and 39 plus non-progressive bonus payout for line 32 that, in combination, yield a total bonus game payout of 3,505 credits ($35.05) resulting from the single spin primary game of this embodiment.

In one embodiment, one or more aspects of the volatility of the MPRVA feature may be altered under certain circumstance(s) or upon the occurrence of particular event(s). As non-limiting examples described above, the trigger may be changed from a “five-of-a-kind” payline to a “five-of-a-kind” anywhere within the symbol array, thereby triggering more game outcomes to be progressive-eligible and increasing the players' chances of receiving a progressive award. Likewise, the manner in which the frame overlay pseudo-reel assigns values to the progressive-eligible symbols may be changed from individual spins for each eligible symbol to a single spin for all elements with the most favorable valuation for the player being assigned to all of the symbols. Finally, the frame overlay placements based on one or more pseudo-reel spins may be altered in view of the results of a prior symbol valuation by removing and replacing frame overlays also as described above. The effect of these and other similar changes to features of the MPRVA game will affect the volatility of the progressive aspects of the game. However, since none of these changes comprise any changes to the original game outcome displayed via the array of symbols, the volatility of the underlying base game is likewise unchanged. This provides a great degree of independence between the respective volatilities of the base game awards as prescribed by the base game's paytable and the progressive awards determined by the MPRVA methods taught herein. As described further below, this is particularly advantageous when the operators of each game are not the same party; for example, when operation of the base game is owned and provided by the casino operator in whose gaming facility the participating EGM is located and operation of the wide-area progressive game is owned and provided by a third party, such as but not limited to a gaming equipment manufacturer or gaming system provider. If a WAP provider elects to vary the volatility of the progressive aspects of the game, the trigger specification(s) or the valuation processes may be modified via server-based reconfiguration methods known in the art without altering the play, presentation, or paytable of the base game owned and provided by the respective casino operator(s). Since the base game outcome is determined and presented to the player in advance of the valuation and awarding of progressive jackpot rewards, and no symbols are changed and no reels are re-spun on the base game to accommodate the subsequent progressive method steps, the progressive game features may be altered at will and are completely independent of the base game.

One non-limiting example of circumstances or events that might merit a change in the volatility of the progressive game features is the desire to encourage play of the progressive-enabled games on certain days or during certain hours. This may be used to attract players to gaming establishments during typically slower times. Likewise, volatility may be decreased during periods when the establishment is already full and it is desirable to allow the progressive jackpot pools to increase in value. This disclosure is intended to encompass a change in the specific configuration of the MPRVA game features, including volatility, for any reason or purpose deemed useful or beneficial for players or operators.

When one or more accumulated progressive jackpot(s) have not been recently awarded, particularly in wide-area progressive games with the play of many EGMs contributing to those jackpot pools, their value may be uncharacteristically high and thereby draw the attention of players and potential players. As more players participate, the value of the jackpot(s) will continue to increase. In some embodiments, the MPRVA trigger(s) may be changed to permit more players to become eligible for progressive award(s) or to otherwise increase the odds of being won sooner rather than later or later rather than sooner. In one embodiment, the likelihood that particular jackpot(s) may be won can be controlled to such a degree that the progressive provider can predict when the jackpot(s) will be awarded with a high degree of accuracy by manipulating the number of game outcomes eligible for a progressive reward and by adjusting the various parameters of the eligible symbol valuation process. After the progressive jackpot(s) in question have been awarded, the adjusted MPRVA game feature(s) may be returned to their default or any other preferred state(s).

A principal advantage of this invention that the awards payable to players from the play of both the primary base game and the progressive bonus game are determined by the symbols and their respective positions determined by the outcome of a single spin of the primary base game. Unlike other progressive games known in the art, there is no need for a player to initiate any additional spins that change the position of the base game symbols or position any symbols pertaining to the progressive bonus game.

In some embodiments of this invention, and as discussed briefly above, the operation of a base game and the progressive bonus game are connected to a single revenue stream; that is, all of the players' wagers and user jackpot payouts for the base games and the bonus games are received from and directed to, respectively, a single entity, such as the operator of the casino in which the game is physically located, a gaming licensee under whose authority the game is operated and maintained such as a slot machine route operator, or the provider of a WAP game to which the progressive bonus game is linked with the play of other instances of said bonus game in the same or other establishments. When the revenue and jackpots are both attributable to a single entity in this manner, the game characteristics, associated base game award(s), and any progressive bonus game award(s) may be determined from a single outcome selected by a pseudo random number generator (PRNG) for a Class III game or from a single outcome provided by a central outcome server to a Class II machine, such as in a bingo-based game. Once the outcome has been determined by or provided to the EGM, all of the awards to be paid to the player have already been determined and all that remains is for the EGM to provide a visual display of the game outcome that corresponds to that particular outcome and pay any awards to the player.

Another principal advantage of the invention is that it provides some measure of independence between the monetary aspects of the primary base game and the progressive bonus game, if desired, despite the fact that the awards for both games are still based on the symbols and their relative positions resulting from a single spin of the primary base game. Presently, many EGMs used to present WAP games to players are owned by the WAP provider and leased to casino operators for a fee. The casino operators may share in a portion of the net revenue generated by those machines, but a significant portion of said revenue is retained by the WAP provider. Casino operators may own or have contracted to receive full benefits of the operation of non-WAP EGMs outright and are therefore entitled to all of the net revenue generated by those machines. In other instances, there may be other financial arrangements to distribute the cost and benefits of EGM operation between casino operators, EGM manufacturers or suppliers, WAP providers, and other associated parties. Some aspects of EGM ownership are generally more favorable to casino operators but such ownership often precludes offering a wide-area progressive game in which more than one operator's EGMs may share progressive jackpot pools. That is, EGMs under the control of casino operators may have limited, if any, opportunity to provide WAPs in addition to their base games. The MPRVA game methods described herein solve the limitations present in the known art where the base game and the progressive feature(s) are owned by different parties, potentially with different revenue streams, and where changes to one game would necessarily affect the volatility of the other. This invention provides improved means for operators who control EGMs independent of WAP providers to place progressive games on those independent EGMs and configure their respective games to share revenue in an manner effective for both parties. This is enabled by providing a substantial measure of independent control of the base and bonus games.

A novel element of this invention allows the WAP provider to alter the operation, including but not limited to the volatility, of the progressive game and awards without altering any aspect of the underlying base game. In one such embodiment, the progressive bonus game jackpots payable to the player would be determined by the WAP provider based on its own preferred MPRVA paytable applied to the base game outcome symbols and placement instead of being inflexibly linked to that outcome as in the single revenue stream embodiment described above. The MPRVA paytable may include, without limitation, data relative to any aspect(s) of MPRVA game configuration, such as the initial value(s) of progressive bonus jackpots, how contributions from primary base game wagers are distributed among the various progressive bonus jackpots, the probabilities of awarding said bonus jackpots to players, and the like.

Independent control of the primary base game and the MPRVA game can be accomplished in several ways, but as one non-limiting example, the WAP provider may elect to generate or receive a second PRNG outcome based on the symbol placement from the primary base game and use that second outcome to determine any jackpot awards payable to the player. Once the base game outcome has been determined, a second outcome may be generated that is exclusively applied to determine the jackpot level assignments for the progressive bonus game. Again, the symbols and placements from the primary base game do not change as a result of any second outcome generated by the WAP provider in this embodiment; said second outcome only affects the manner in which progressive bonus game jackpots are awarded to the player based on the symbol placement from the primary base game.

For example, if the same “five-of-a-kind payline” trigger described above is utilized in a WAP provider “second outcome” embodiment, the progressive bonus jackpot level assigned to each of those paylines may be determined, at least in part, by the number of such paylines in the primary base game array. The mechanism and visual depiction for determining which of the specific jackpot(s) are to be awarded to each bonus-eligible payline may be the same as previously described, but the particular bonus jackpots selected by the game may be determined, at least in part, by the second outcome. In one embodiment, the greater the number of paylines eligible for a progressive bonus award, the more likely that lower level jackpot awards will be selected than if fewer such paylines were present in the single spin primary base game outcome. In one embodiment, the higher valued progressive jackpot awards may be awarded only when a certain minimum number of trigger paylines are present in the primary base game outcome array. In one embodiment, awarding a certain jackpot award for a first eligible payline removes that particular award from the list of possible awards for other paylines present in the primary base game outcome array. Any number of other possible embodiments are contemplated by this disclosure and a person of ordinary skill in the art will immediately recognize such possibilities and that they are limited only by the imagination of the game designer.

In this manner, operators are free to maintain their preferred paytables, payback percentages, and volatility while the WAP provider is free to independently change those same aspects of the progressive bonus game(s) via a separate paytable operative only upon that game even though the same primary base game symbol array forms the basis for awards in both games. In this embodiment, access to each of the primary base game paytable and the progressive bonus game paytable may be restricted to only their respective operator(s) or provider(s). This independence of base game(s) and progressive game(s) is a novel improvement over the known art and represents a new class of progressive gaming enhancements that would inure to the advantage of casino operators who could collectively offer their own WAPs, even in conjunction with different base games, without the involvement or participation of gaming equipment or system providers.

It is important to note that in a single outcome embodiment, the base game and progressive bonus game awards are determined via that single outcome generated or received at the outset of the game. What appears to the player to be a spin of several video pseudo-reels, the assignment of progressive bonus jackpot levels to each of the eligible symbol positions, and the calculation and awarding of jackpot payouts is merely a graphical depiction of a previously-determined outcome. In this case, actions such as “assignment of progressive bonus jackpot levels” that appear to the user to be occurring in real time are actually the result of an outcome previously generated or received by the EGM and a corresponding paytable entry that prescribes the visual outcome provided by the EGM. Accordingly, the “single outcome” game embodiment does not need to “determine” the next step in the game method based on the results of the previous steps since all of the steps may be most simply packaged into the particular visual outcome presentation associated with that pseudo-random outcome. When either the primary base game or the progressive bonus game is to be modified, the process is accomplished merely by substituting an alternate paytable and associated visual outcome presentation in place of the previous versions. The play of either or both games may be modified in this way.

However, in the “second outcome” embodiment, the progressive bonus game may be configured to react to the primary base game outcome using a separate paytable and visual outcome presentations that may be separate and distinct from those associated with the primary base game. This embodiment does not necessarily require gaming outcomes different than those from the “single outcome” embodiment if the symbol array size and symbols assigned to each of the pseudo-reels remain unchanged. What may be changed, if desired, is the probability of particular bonus game outcomes being selected and utilized for progressive jackpot awards. In this embodiment, the primary base game may be configured to generate a symbol table or other data structure representing all or a portion of the symbols and their placements from the player's primary base game spin and to communicate said table or data structure to the progressive bonus game. The progressive bonus game may then utilize its own paytable in conjunction with a second generated or received outcome and said data communicated from the primary base game to determine and provide the user with bonus jackpot awards and the associated visual outcome presentations. As is possible with the “single outcome” embodiment, the MPRVA bonus game may be modified without any required change to the primary base game but without the need to access or replace its paytable. In certain networked environments, including a MPRVA game delivered to an EGM from a remote location, a “second outcome” embodiment that delivers the appropriate visual outcome presentation for the MPRVA feature to a player's EGM may provide additional flexibility for independent configuration of the primary base game and the progressive bonus game. In yet another embodiment, the WAP provider may generate and communicate said second outcome to the EGM, thereby enabling the EGM to complete the MPRVA game using its own local resources.

While the foregoing disclosure sets forth various exemplary embodiments using specific drawings and descriptions, one or more of said embodiments may be achieved by other means evident to persons of ordinary skill in the art and are thereby contemplated by the instant disclosure. For example, certain embodiments may be implemented in hardware structure, computer software or firmware, by one or more humans, by other means, or by any combination of some or all of the above. Applicant's disclosure in its written description and claims must be considered in its entirety for all it teaches and claims and not as a series of disparate and unrelated pieces. Certain elements of this invention may be independently operable but may not be properly separated from the invention as a whole for purposes of determining patentability. For example, combinations of known elements to achieve a system or method previously unknown in the art would, by definition, comprise a novel invention for purposes of patentability and would further comprise “significantly more” than the simple use of known elements to achieve predictable results. Reduction of Applicant's invention to disparate elements in an attempt to deem said invention as obvious over known art without appreciation for the novelty of the combination of said elements would fail to appreciate the invention as a whole.

With respect to methods and processes, it will be recognized by persons of ordinary skill in the art that certain of the steps in said methods or processes are not necessarily required to be performed in the order taught by Applicant's recitation. When process or method steps may be performed in an alternative order such that the results achieved by said process or method are equivalent to those taught by Applicant, such alternate order of performance are envisioned by the scope of this disclosure. A person of ordinary skill in the art will appreciate the extent to which one or more step(s) of any process or method taught or claimed herein must necessarily precede another, but in all other instances, the scope of Applicant's disclosure should be viewed as inclusive of the family of processes or methods comprising equivalent steps that achieve the results taught and claimed by Applicant's process and method steps in any order of performance. Further, certain process or method steps may not be required for one or more embodiments, and such embodiments also fall within the scope of this disclosure.

Unless otherwise noted herein, the descriptive articles “a” or “an,” as used in the specification and claims are to be construed as meaning “at least one of”. Thus, for example, recitation of combinations of elements such as “at least one of any of A, B, and C” describes any manner of combination of said elements, including combinations comprising A, B, C, A and B, A and C, B and C, or A and B and C.

Further, whenever the singular form of an object is used or implied, the use of the plural is understood to be included, and vice versa. For example, the term “input device” may refer to one such device or more than one such device. Terms denoting one or more, such as “input device(s)”, are used herein for grammatical propriety where deemed applicable and are not to be distinguished from usage where only the singular or plural are used unless expressly stated otherwise.

Applicant has described its invention in the context of certain embodiments, some preferred over others in certain instances, for certain purposes, or both. The scope of this disclosure is intended to encompass all embodiments related to the disclosed subject matter and for all useful purposes to which said embodiments may be applied. The exemplary embodiments listed herein are provided to be enabling rather than limiting, as persons of ordinary skill in a great variety of arts will immediately recognize how the apparatus, systems, and methods disclosed herein may readily be applied to aspects of their arts, and such applications are therefore additionally enabled by Applicant's disclosure and therefore fall within its scope.

What is claimed is:

1. An electronic wagering game operating on an electronic gaming machine, said game comprising steps of:
A. receiving a wager from a player, generating locally or receiving from a remote source a pseudo-random primary base game gaming outcome, displaying an array of symbols comprising a visual depiction associated with said outcome, and providing any award(s) to the player associated with said outcome according to a pre-defined paytable;
B. displaying to the user the presence and position(s) of any symbol(s) in said array comprising an outcome or payline defined as eligible for a progressive bonus jackpot award;
C. presenting to the user a bonus award level assignment for symbols occupying a pre-determined position in each of said eligible payline(s) from the set of possible assignments comprising all available progressive bonus jackpot awards and the possibility of no progressive bonus jackpot award;
D. calculating the progressive bonus jackpot award for each eligible payline according to the assigned bonus award level and said pre-defined paytable; and
E. providing the value of each of said progressive bonus jackpot award(s) to the player.

2. The electronic wagering game of claim 1 wherein the step of presenting to the user a bonus award level assignment comprises a step of providing a visual display to the user that depicts a sequence of possible bonus award levels at each of said pre-determined positions in each of said pre-defined paylines.

3. The electronic wagering game of claim 2 wherein said visual display comprises a pseudo-reel overlay scrolling across more than one of said pre-determined positions in each of said pre-defined paylines until stopping when a bonus award level is designated.

4. The electronic wagering game of claim 2 wherein said visual display comprises a pseudo-reel overlay scrolling across only one of said pre-determined positions at a time in each of said pre-defined paylines until stopping when a bonus award level is designated.

5. The electronic wagering game of claim 1 wherein the step of calculating the progressive bonus jackpot award(s) comprises the step of calculating a first award at any bonus award level using the present value of each of said bonus jackpot award(s) and resetting all of said awarded bonus jackpot(s) to an initial value.

6. The electronic wagering game of claim 5 wherein the step of calculating the progressive bonus jackpot award(s) comprises the step of calculating a second or any subsequent bonus jackpot award(s) at a previously-awarded bonus award level using the initial value of each of the bonus jackpot award(s).

7. The electronic wagering game of claim 1 further comprising a step of generating locally or receiving from a remote source a pseudo-random progressive bonus game gaming outcome and using said pseudo-random progressive bonus game gaming outcome to calculate, in part, said progressive bonus jackpot award(s) for each said eligible pre-defined payline.

8. The electronic wagering game of claim 1 wherein said primary base game is configured to generate a symbol table or other data structure comprising at least a portion of the symbols and their placements from the play of said primary base game and to communicate said table or data structure to said progressive bonus game for use in calculating, in part, said progressive bonus jackpot award(s) for each said eligible pre-defined payline.

9. The electronic wagering game of claim 1 wherein said paytable comprises a first primary base game paytable and a second progressive bonus game paytable, and wherein said first primary base game paytable is used to determine said first primary base game awards and said second progressive bonus game paytable is used to determine said second progressive bonus jackpot awards.

10. The electronic wagering game of claim 9 wherein said first primary base game paytable is accessible only to the operator of said first primary base game and said second progressive bonus game paytable is accessible only to the operator of said progressive bonus game.

11. A method of awarding progressive bonus game jackpots using the symbol array from a primary base game, the method comprising steps of:
A. prior to playing a primary base game, defining one or more possible outcome(s) or payline(s) in said primary base game array operative to trigger the awarding of at least one bonus jackpot;
B. prior to playing a primary base game, defining which symbol position(s) in each of said possible outcome(s) or payline(s) are eligible to be assigned progressive bonus jackpot levels for the purpose of calculating a player's award;
C. associating each possible gaming outcome with a gaming symbol array that may comprise at least one of said one or more triggering outcome(s) or payline(s);
D. accepting a gaming wager from a user, generating locally or receiving from a remote source a pseudo-random primary base game gaming outcome, and displaying an array of symbols comprising a visual depiction associated with said outcome;
E. if said array of symbols comprises at least one of said one or more triggering outcome(s) or payline(s), assigning either a progressive bonus jackpot level or the absence of a progressive bonus jackpot level to the symbol(s) at said defined eligible position(s) in each of said triggering outcome(s) or payline(s);
F. if a progressive bonus jackpot level is assigned to any of said symbol(s) at said defined eligible position(s), calculating the progressive bonus jackpot award(s) for each of said one or more triggering outcome(s) or payline(s) present in said symbol array using said assigned progressive bonus jackpot level(s); and
G. awarding the player the sum of all such calculated bonus jackpot awards resulting from said symbol array.

12. The method of claim 11 wherein the step of assigning a progressive bonus jackpot level to the symbol(s) at said defined eligible position(s) comprises an additional step of providing a visual display to the user that depicts a sequence of possible bonus award levels at each of said eligible position(s) in each of said one or more triggering outcome(s) or payline(s).

13. The method of claim 12 wherein said visual display comprises a pseudo-reel overlay scrolling across more than one of said eligible position(s) in each of said one or more triggering outcome(s) or payline(s) until stopping when a bonus award level is designated.

14. The method of claim 12 wherein said visual display comprises a pseudo-reel overlay scrolling across only one of said eligible position(s) at a time in each of said one or more triggering outcome(s) or payline(s) until stopping when a bonus award level is designated.

15. The method of claim 11 wherein the step of calculating the progressive bonus jackpot award(s) comprises the step of calculating a first award at any bonus award level using the present value of each of said bonus jackpot award(s) and resetting all of said awarded bonus jackpot(s) to an initial value.

16. The method of claim 15 wherein the step of calculating the progressive bonus jackpot award(s) comprises the step of calculating a second and any subsequent bonus jackpot awards at a previously-awarded bonus award level using the initial value of each of the bonus jackpot award(s).

17. The method of claim 11 further comprising an additional step of generating locally or receiving from a remote source a pseudo-random progressive bonus game gaming outcome and using said pseudo-random progressive bonus game gaming outcome to calculate said progressive bonus jackpot award(s) for each of said pre-defined paylines.

18. The method of claim 17 wherein said primary base game is configured to generate a symbol table or other data structure comprising at least a portion of the symbols and their placements from the play of said primary base game and to communicate said table or data structure to said progressive bonus game for use in calculating, in part, said progressive bonus jackpot award(s) for each of said one or more triggering outcome(s) or payline(s).

19. The method of claim 11 wherein (a) said defined one or more possible triggering outcome(s) or payline(s) in said primary base game array, said defined symbol position(s) in each of said possible outcome(s) or payline(s) eligible to be assigned progressive bonus jackpot levels, and said association between each possible gaming outcome and gaming symbol array comprise(s) a portion of a first primary base game paytable, (b) data relative to the initial value(s) of said progressive bonus jackpots, allocation instructions for primary base game wager contributions, and the probabilities of awarding said bonus jackpots to players comprise a portion of a second progressive bonus game paytable, and (c) said first and second paytables are utilized in part to calculate said progressive bonus jackpot award(s) for each of said one or more triggering outcome(s) or payline(s).

20. The method of claim 19 wherein said first primary base game paytable is accessible only to the operator of said first primary base game and said second progressive bonus game paytable is accessible only to the operator of said progressive bonus game.
